(19) United States
(12) Patent Application Publication
(10) Pub. No.: US 2008/0290534 A1
(43) Pub. Date: Nov. 27, 2008

(54) OPHTHALMIC LENS MOLD SURFACE ENERGY DIFFERENTIAL

(76) Inventors: Changhong Yin, St. Augustine, FL (US); Scott F. Ansell, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/753,198

(22) Filed: May 24, 2007

(51) Int. Cl. B29D 11/00

(52) U.S. Cl. 264/1.36; 359/643; 425/175

(57) ABSTRACT

This invention discloses improved mold parts fashioned from a thermoplastic resin compounded with an additive to reduce the surface energy of the mold part. The mold parts can be used in manufacturing processes, such as, for example: continuous, in-line or batched processes of ophthalmic lens molds.

### FIELD OF USE

This invention describes molds and ophthalmic lenses formed with the molds and a surface energy differential therebetween.

### BACKGROUND

It is well known that contact lenses can be used to improve vision. Various contact lenses have been commercially produced for many years. Early designs of contact lenses were fashioned from hard materials. Although these lenses are still currently used in some applications, they are not suitable for all patients due to their poor comfort and relatively low permeability to oxygen. Later developments in the field gave rise to soft contact lenses based upon hydrogels.

Hydrogel contact lenses are popular and often more comfortable to wear than contact lenses made of hard materials. Malleable soft contact lenses made from hydrogels can be manufactured by forming a lens in a multi-part mold where the combined parts form a topography consistent with the desired final lens.

Ophthalmic lenses are often made by cast molding, in which a monomer material is deposited in a cavity defined between optical surfaces of opposing mold parts. Multi-part molds used to fashion hydrogels into a useful article, such as an ophthalmic lens, can include for example, a first mold part with a convex portion that corresponds with a back curve of an ophthalmic lens and a second mold part with a concave portion that corresponds with a front curve of the ophthalmic lens. To prepare a lens using such mold parts, an uncured hydrogel lens formulation is placed between a front curve mold part and a back curve mold part. The mold parts are brought together to shape the lens formulation according to desired lens parameters. Traditionally, a lens edge was formed about the perimeter of the formed lens by compression of an edge formed into the mold parts which penetrates the lens formulation and incises it into a lens portion and an excess ring portion. The lens formulation was subsequently cured, for example by exposure to heat and light, thereby forming a lens.

Following cure, mold portions are separated and the lens remains adhered to one of the mold portions. The lens and the excess polymer ring must be separated and the excess polymer ring discarded. During mold separation, lens damage may occur. Damage can include, for example: edge chips and tears; holes; lens delamination or pulls; lenses adhering to a wrong mold part, optical distortion; and surface marks. In addition, it is sometimes difficult and time consuming release a formed lens from a mold part to which the lens adheres following demold.

It is desirable therefore to have a correlation of mold materials and lens materials that facilitate demold and lens release.

### SUMMARY

Accordingly, the present invention includes improved molds and processes useful in the creation of an ophthalmic lens. A mold material can be used with one or more additives which reduce the surface tension of the mold material and increase a differential between one or both mold parts and the lens formed therebetween. According to the present invention, a lens forming mixture is cured in a cavity of a desired shape formed by two or more mold parts. At least one of the mold parts is molded from a material with a differential in surface energy between a mold used to form an ophthalmic lens and the ophthalmic lens formed.

Embodiments can include at least one of the mold parts being transparent to polymerization initiating radiation such that a polymerizable lens forming mixture can be deposited in the cavity and the mold part and polymerizable composition can be exposed to polymerization initiating radiation.

Embodiments can also include methods of producing an ophthalmic lens by dispensing an uncured lens formulation onto a surface of a mold part with a surface tension less than 30 mN/m. The lens can include, for example, a silicone hydrogel formulation or a hydrogel formulation. Specific examples can include a lens formed from: acquafilcon A, balafilcon A, and lotrafilcon A, etafilcon A, genfilcon A, lenefilcon A, polymacon and galyfilcon A, and senofilcon A.

### DESCRIPTION OF THE DRAWINGS

FIG. 1 illustrates a mold assembly according to some embodiments of the present invention.

FIG. 2 illustrates a flow chart of exemplary steps that can be executed while implementing some embodiments of the present to create a mold part.

FIG. 3 illustrates a flow chart of exemplary steps that can be executed while implementing some embodiments of the present to create an ophthalmic lens.

FIG. 4 illustrates a chart with exemplary data indicating surface energy qualities of molds fashioned from thermoplastic resins and compounds of thermoplastic resins.

FIG. 5 illustrates a chart with lens release time data as it relates to different mold part materials.

### DETAILED DESCRIPTION OF THE INVENTION

The present invention includes molds and methods for making an ophthalmic lens. According to some embodiments of the present invention, at least one part of a multi-part mold that is used in the manufacture of an ophthalmic lens, is injection molded from a thermal plastic resin (hereinafter referred to as “TPR”) compounded with an additive to reduce the surface energy of the mold material.

According to the present invention selection of mold part materials and monomers which result in an increased surface energy differential between monomers or cured lenses and FC molds facilitates silicone hydrogel easy lens release during aqueous hydration. Generally, surface energy differential or “delta” can defined as Surface Energy of Monomer or Cured Lens—Surface Energy of Mold Part. Accordingly, preferred embodiments include a surface energy of delta between a front curve mold part and a lens that is greater than 0.

The mechanisms of adhesion are generally the result of surface energy related parameters relating to the two surfaces that are in contact. According to the present invention, use of mold materials with low surface energy, such as, for example, ≦30 mN/m or less, as front curve (FC) reduces adhesive force or adhesion energy between cured lens and FC mold, and, therefore, facilitate easier and faster silicone hydrogel lens release during aqueous hydration.

In addition to use of a low surface energy FC mold (≦30), increasing monomer surface energy should also reduce adhesive force or adhesion energy between cured lens and FC mold. This should also benefit easier and faster lens release from FC mold during hydration, including aqueous hydration. FC mold materials with lower surface energy (≦30 mN/m) can be successfully obtained by compounding PP with selective additives, such as Siloxane MB50-001 and Trilwet A.

In some embodiments of the present invention, ophthalmic lens molds comprising TPR and additive blends result in a mold surface energy of an uncoated ophthalmic lens mold of about 30 mN/m or less. Methods of the present invention therefore include fashioning an ophthalmic lens from a mold with one or more mold part having an uncoated surface energy of about 30 mN/m or less.

One or both mold parts utilized to form an ophthalmic lens is injection molded from a TPR with an additive or other mechanism to reduce the surface energy of the mold part to less than 30 mN/m. Injection molding apparatus will typically include precision tooling that has been machined from a metal, such as, for example, brass, stainless steel or nickel or some combination thereof. Typically, tooling is fashioned in a desired shape and machined or polished to achieve precision surface quality. The precision surface in turn increases the quality of a mold part injection molded therefrom.

In some preferred embodiments, mold parts are fashioned from a thermoplastic polyolefin with an additive to produce single use cast molds with a surface energy of less than 30 mN/m which reduces the adhesive force between a cured lens and mold parts used to fashion the lens and is therefore conducive to the manufacture of ophthalmic lenses. Advantages of utilizing molds comprising a thermoplastic polyolefin material with an additive which results in a surface energy of less than 30 mN/m include a diminished number of lens defects, such as holes, chips and tears resulting from demold; and also improved release from a mold part in which it is formed.

### Lenses

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

As used herein, the term “lens forming mixture” refers to a mixture of materials that can react, or be cured, to form an ophthalmic lens. Such a mixture can include polymerizable components (monomers), additives such as UV blockers and tints, photoinitiators or catalysts, and other additives one might desire in an ophthalmic lens such as a contact or intraocular lens.

In some embodiments, a preferred lens type can include a lens that is made from silicone elastomers or hydrogels, such as, for example, silicone hydrogels, fluorohydrogels, including those comprising silicone/hydrophilic macromers, silicone based monomers, initiators and additives. By way of non-limiting example, some preferred lens types can also include etafilcon A, genifilcon A, lenefilcon A, polymacon, acquafilcon A, balafilcon A, lotrafilcon A, galyfilcon A, senofilcon A, silicone hydrogels.

### Molds

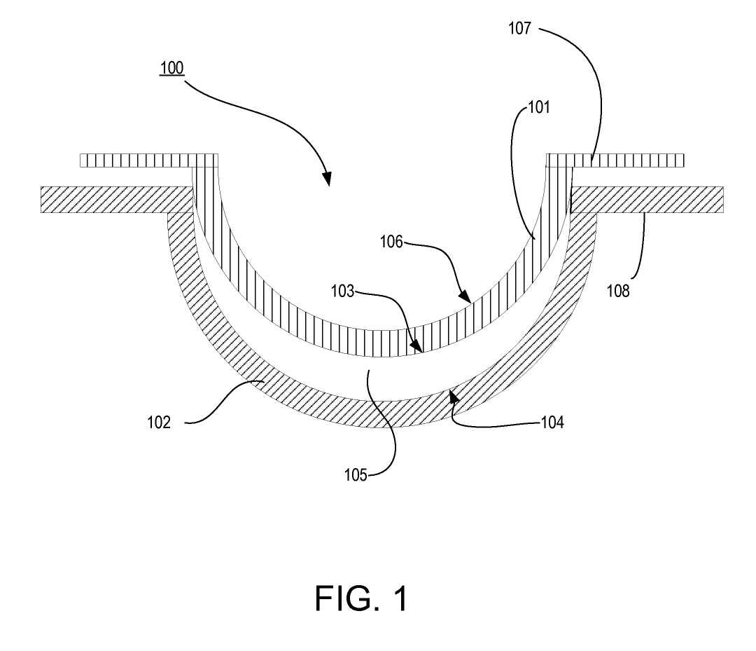

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture (not illustrated), an ophthalmic lens of a desired shape is produced. The molds and mold assemblies 100 of this invention are made up of more than one “mold parts” or “mold pieces” 101-102. The mold parts 101-102 can be brought together such that a cavity 105 is formed between the mold parts 101-102 in which a lens can be formed. This combination of mold parts 101-102 is preferably temporary. Upon formation of the lens, the mold parts 101-102 can again be separated for removal of the lens.

At least one mold part 101-102 has at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102.

Thus, for example, in a preferred embodiment a mold assembly 100 is formed from two parts 101-102, a female concave piece (front piece) 102 and a male convex piece (back piece) 101 with a cavity formed between them. The portion of the concave surface 104 which makes contact with lens forming mixture has the curvature of the front curve of an ophthalmic lens to be produced in the mold assembly 100 and is sufficiently smooth and formed such that the surface of a ophthalmic lens formed by polymerization of the lens forming mixture which is in contact with the concave surface 104 is optically acceptable.

In some embodiments, the front mold piece 102 can also have an annular flange integral with and surrounding circular circumferential edge 108 and extends from it in a plane normal to the axis and extending from the flange (not shown).

The back mold piece 101 has a central curved section with a concave surface 106, convex surface 103 and circular circumferential edge 107, wherein the portion of the convex surface 103 in contact with the lens forming mixture has the curvature of the back curve of a ophthalmic lens to be produced in the mold assembly 100 and is sufficiently smooth and formed such that the surface of a ophthalmic lens formed by reaction or cure of the lens forming mixture in contact with the back surface 103 is optically acceptable. Accordingly, the inner concave surface 104 of the front mold half 102 defines the outer surface of the ophthalmic lens, while the outer convex surface 103 of the base mold half 101 defines the inner surface of the ophthalmic lens.

In some preferred embodiments, molds 100 can include two mold parts 101-102 as described above, wherein one or both of the front curve part 102 and the back curve part 101 of the mold 100 comprises a thermoplastic polyolefin compound with a surface energy of less than 30 mN/m.

Blended mold material resins can be obtained, for example, using different compounding methods, including hand blending, single screw compounding, twin screw and/or multiple screw compounding.

Preferred embodiments of a mold material include a polyolefin; cyclic olefins; and cyclic olefin copolymers; including, in some embodiments polyolefins and COCs. Additives that may be compounded with the preferred mold materials include:

a) Siloxanes including a class of organosilicon compounds with empirical formula R₂SiO, where R is an organic group;

b) non-ionic surfactants such as: alkyl ethoxylates and glycerol monostearate; and

c) a polymer made from the monomer N-vinyl pyrrolidone, such as Polyvinylpyrrolidone.

Siloxanes can include [SiO(CH₃)₂]ₙ (dimethylsiloxane) and [SiO(C₆H₅)₂]ₙ (diphenylsiloxane), where n is typically >4. Siloxane orgaosilicon compounds can include both organic and inorganic chemical compounds. Organic side chains can confer hydrophobic properties and an —Si—O—Si—O— backbone is inorganic.

Glycerol monostearate can include a lipophilic non-ionic surfactant with HLB of 3.6-4.2 and a chemical formula of CH3(CH2)16COOCH2CHOHCH2OH.

Polyvinylpyrrolidone can include a nonionic powder with the chemical formula (C₆H₉NO)ₓ.

Specific examples of additives that decrease the surface energy of a mold material predominantly made up of one or more of: polyolefin; cyclic olefins; and cyclic olefin copolymers; include:
1. Silixone® MB50-001 from Dow Corning;
2. Trilwet A® from Trillium Specialties LLC;
3. Glycerol Monostearate (GMS) from SparTech, Inc.; and
4. PVP K-90 from International Specialty Products.

Preferred embodiments can also include a polyolefin of one or more of: polypropylene, polystyrene, polyethylene, polymethyl methacrylate, and modified polyolefins.

Thermoplastics that can be compounded with an additive can include, for example, one or more of: polypropylene, polystyrene and alicyclic polymers.

In some embodiments the thermoplastic resin can include an alicyclic polymer which refers to compounds having at least one saturated carbocyclic ring therein. The saturated carbocyclic rings may be substituted with one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents are selected from one or more members of the group consisting of halogen, hydroxyl, C₁₋₁₀alkoxycarbonyl, C₁₋₁₀alkoxy, cyano, amido, imido, and silyl. Examples of alicyclic polymers include but are not limited to polymerizable cyclobutanes, cyclopentanes, cyclohexanes, cycloheptanes, cyclooctanes, biscyclobutanes, biscyclopentanes, biscyclohexanes, biscycloheptanes, biscyclooctanes, and norbornanes. It is preferred that the at least two alicyclic polymers be polymerized by ring opening metathesis followed by hydrogenation. Since co-polymers are costly, it is preferable that the molds made from these co-polymers may be used several times to prepare lenses instead of once which is typical. For the preferred molds of the invention, they may be used more than once to produce lenses.

More particularly, examples of alicyclic polymer containing saturated carbocyclic rings include but are not limited to the following structures

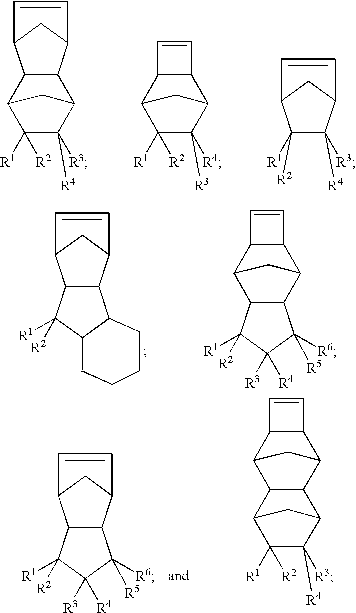

wherein R¹^{_{—}}⁶ are independently selected from one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents selected from one or more members of the group consisting of halogen, hydroxyl, C₁₋₁₀alkoxycarbonyl, C₁₋₁₀alkoxy, cyano, amido, imido and silyl. Further two or more of R¹⁻⁶ may be taken together to form an unsaturated bond, a carbocyclic ring, a carbocyclic ring containing one or more unsaturated bonds, or an aromatic ring. The preferred R¹⁻⁶ is selected from the group consisting of C₁₋₁₀alkyl and substituted C₁₋₁₀alkyl where the substituents are selected from the group consisting of halogen, hydroxyl, C₁₋₁₀alkoxycarbonyl, C₁₋₁₀alkoxy, cyano, amido, imido and silyl.

The alicyclic co-polymers consist of at least two different alicyclic polymer s. The preferred alicyclic co-polymers contain two or three different alicyclic polymer s, selected from the group consisting of

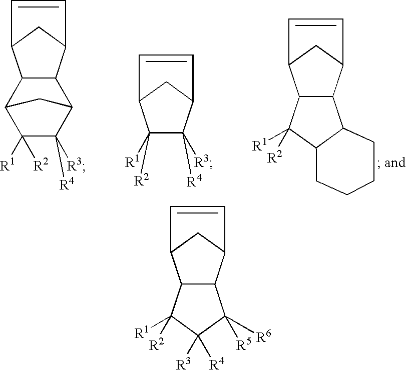

The particularly preferred alicyclic co-polymer contains two different alicyclic monomers where the generic structure of the saturated carbocyclic rings of the alicyclic polymers are of the formula

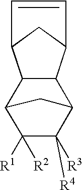

and R¹-R⁴ are C₁₋₁₀alkyl.

Typically the surface energy of the alicyclic co-polymer is between 30 and 45 dynes/cm at 25° C. A preferred alicyclic co-polymer contains two different alicyclic polymers and is sold by Zeon Chemicals L.P. under the trade name ZEONOR. There are several different grades of ZEONOR. Various grades may have glass transition temperatures ranging from 105° C. to 160° C. A specifically preferred material is ZEONOR 1060R, which according the to the manufacturer, ZEON Chemicals L.P. has an melt flow rate (“MFR”) range of 11.0 grams/10 minutes to 18.0 grams/10 minutes (as tested JISK 6719 (230° C.)), a specific gravity (H₂O=1) of 1.01 and a glass transition temperature of 105° C.

Other mold materials that may combined with one or more additives to provide a surface energy of less then 30 mN/m and used to form an ophthalmic lens mold include, for example, Zieglar-Natta polypropylene resins (sometimes referred to as znPP). On exemplary Zieglar-Natta polypropylene resin is available under the name PP 9544 MED. PP 9544 MED is a clarified random copolymer for clean molding as per FDA regulation 21 CFR (c)3.2 made available by ExxonMobile Chemical Company. PP 9544 MED is a random copolymer (znPP) with ethylene group (hereinafter 9544 MED). Other exemplary Zieglar-Natta polypropylene resins include: Atofina Polypropylene 3761 and Atofina Polypropylene 3620WZ.

Still further, in some embodiments, the molds of the invention may contain polymers such as polypropylene, polyethylene, polystyrene, polymethyl methacrylate, modified polyolefins containing an alicyclic moiety in the main chain and cyclic polyolefins, such as, for example Zeonor and EOD 00-11 by Atofina Corporation. For example, a blend of the alicyclic co-polymers and polypropylene (metallocene catalyst process with nucleation, such as ATOFINA EOD 00-11®) may be used, where the ratio by weight percentage of alicyclic co-polymer to polypropylene ranges from about 99:1, to about 20:80 respectively. This blend can be used on either or both mold halves, where it is preferred that this blend is used on the back curve and the front curve consists of the alicyclic co-polymers.

In some preferred methods of making molds 100 according to the present invention, injection molding is utilized according to known techniques, however, embodiments can also include molds fashioned by other techniques including, for example: lathing, diamond turning, or laser cutting.

Typically, lenses are formed on at least one surface of both mold parts 101-102. However, if need be one surface of the lenses may be formed from a mold part 101-102 and the other lens surface can be formed using a lathing method, or other methods.

As used herein “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof.

### Methods

The following method steps are provided as examples of processes that may be implemented according to some aspects of the present invention. It should be understood that order in which the method steps are presented are not meant to be limiting and other orders may be used to implement the invention. In addition, not all of the steps are required to implement the present invention and additional steps may be included in various embodiments of the present invention.

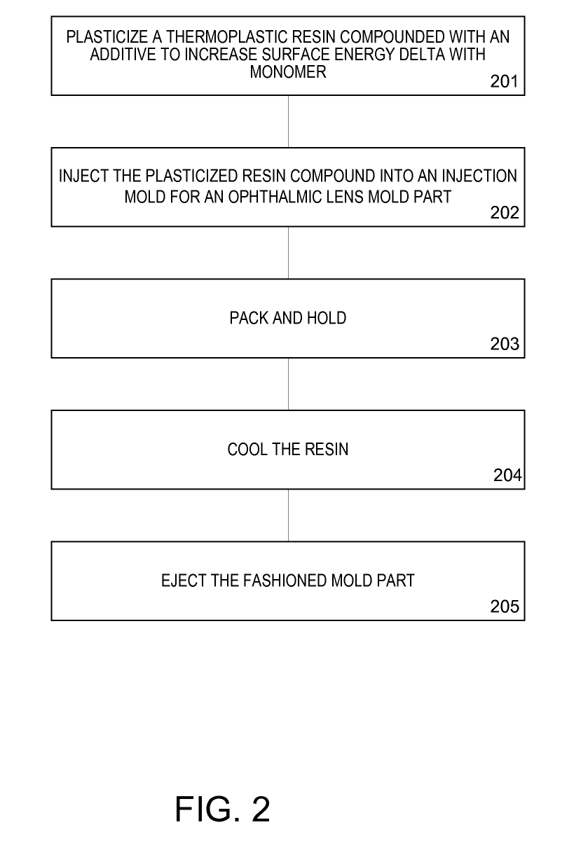

Referring now to FIG. 2, a flowchart illustrates exemplary steps that may be used to implement the present invention. At 201, a resin including a TPE and an additive for reducing the surface energy of the TPE, is plasticized and prepared for use in an injection molding process. Injection molding techniques are well known and preparation typically involves heating resin pellets beyond a melting point.

At 202, the plasticized resin is injected into an injection mold shaped in a fashion suitable for creating an ophthalmic lens mold part 101-102. At 203, the injection mold is typically placed in a pack and hold status for an appropriate amount of time, which can depend, for example upon the resin utilized and the shape and size of the mold part. At 204, the formed mold part 101-102 is allowed to cool and at 205, the mold part 101-102 can be ejected, or otherwise removed from the injection mold.

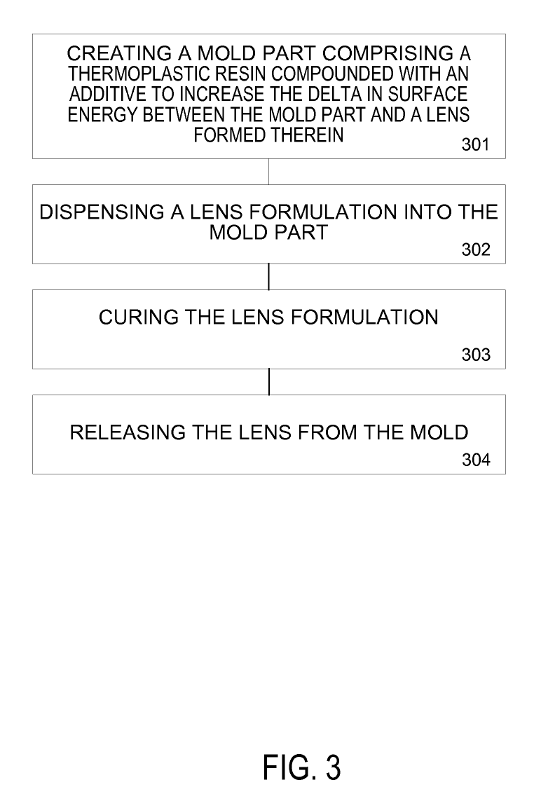

Referring now to FIG. 3, some embodiments of the present invention include methods of making an ophthalmic lens comprising, consisting essentially of, or consisting of the following steps. At 301 one or more mold parts 101-102 are created which comprise, consist essentially of, or consist of, including a TPR compounded with an additive for reducing the surface energy of the TPE. At 302, an uncured lens formulation is dispensed onto the one or more mold parts 101-102 and at 303, the lens formulation is cured under suitable conditions. Additional steps can include, for example, hydrating a cured lens until it releases from a mold part 101-102 and leaching acute ocular discomfort agents from the lens.

As used herein, the term “uncured” refers to the physical state of a lens formulation prior to final curing of the lens formulation to make the lens. In some embodiments, lens formulations can contain mixtures of monomers which are cured only once. Other embodiments can include partially cured lens formulations that contain monomers, partially cured monomers, macromers and other components.

As used herein, the phrase “curing under suitable conditions” refers to any suitable method of curing lens formulations, such as using light, heat, and the appropriate catalysts to produce a cured lens. Light can include, in some specific examples, ultra violet light. Curing can include any exposure of the lens forming mixture to an actinic radiation sufficient to case the lens forming mixture to polymerize.

### Comparative Mold Qualities

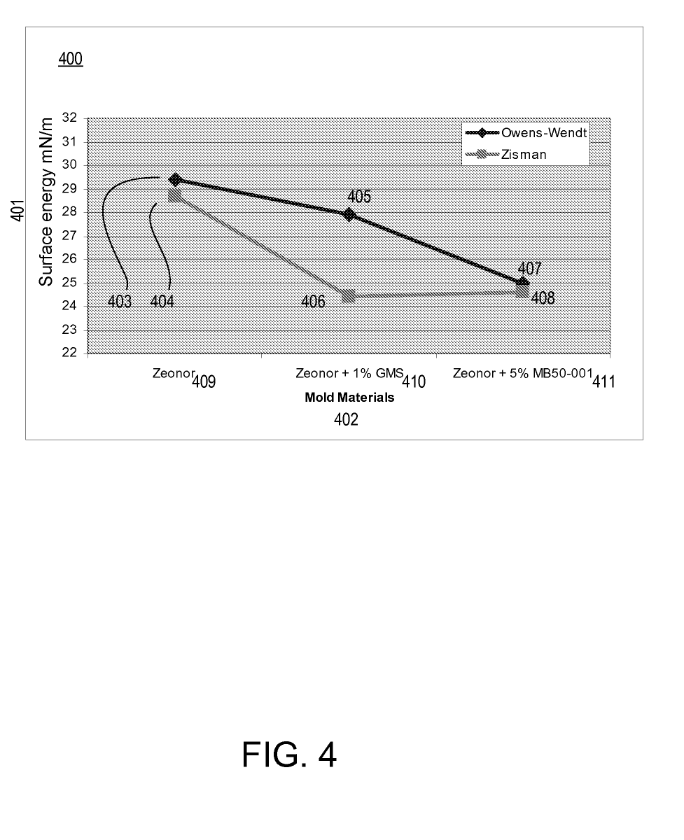

Referring now to FIG. 4, a graph 400 is provided which illustrates surface energy characteristics of mold materials, in including some molds fashioned from a compound including a TPR and an additive for reducing the surface energy of a mold formed from the TPE. Data associated with the chart 400 is included herein as Table 1.

TABLE 1

| | | Owens-wendt | | | Zisman |
|---|---|---|---|---|---|
| | | | Polar | Surface | Surface |
| | Mold | Disperse | (mN/ | Tension | Tension |
| Mold Material | Type | (mN/m) | m) | (mN/m) | (mN/m) |
| PP9544 | FC | 30.31 | 0.00 | 30.31 | 26.39 |
| PP9544 + 1% w.t. | FC | 31.34 | 0.03 | 31.37 | 27.20 |
| MB50-001 | | | | | |
| PP9544 + 2.5% MB50-001 | FC | 28.26 | 0.02 | 28.28 | 32.65 |
| PP9544 + 5% MB50-001 | FC | 28.21 | 0.08 | 28.29 | 24.74 |
| PP9544 + 7.5% w.t. | FC | 32.76 | 0.08 | 32.84 | 28.86 |
| MB50-001 | | | | | |
| PP9544 + 10% w.t. | FC | 33.48 | 0.20 | 33.68 | 28.39 |
| MB50-001 | | | | | |
| Zeonor 1060R | FC | 43.38 | 0.02 | 43.39 | 38.46 |
| 25% Zeonor + 75% PP9544 | FC | 32.79 | 0.02 | 32.81 | 28.21 |
| 55% Zeonor + 45% PP9544 | FC | 33.35 | 0.03 | 33.38 | 28.52 |
| Zeonor + 5% w.t. | FC | 40.07 | 0.78 | 40.85 | 38.68 |
| Trilwet A | | | | | |

As illustrated in the graph 400, mold materials including polypropylene 403-408 and Zeonor 1060R 409-412 were compounded with the additive MB50-001 403-411 or Trilwet A 412. As illustrated, the additives had the effect of decreasing the mold part surface energy 401. A lowest mold surface energy resulted from a compound of polypropylene PP9544 and between 2.5% to 5% MB50-001 depending upon the method used for testing (Owens-wendt or Zisman).

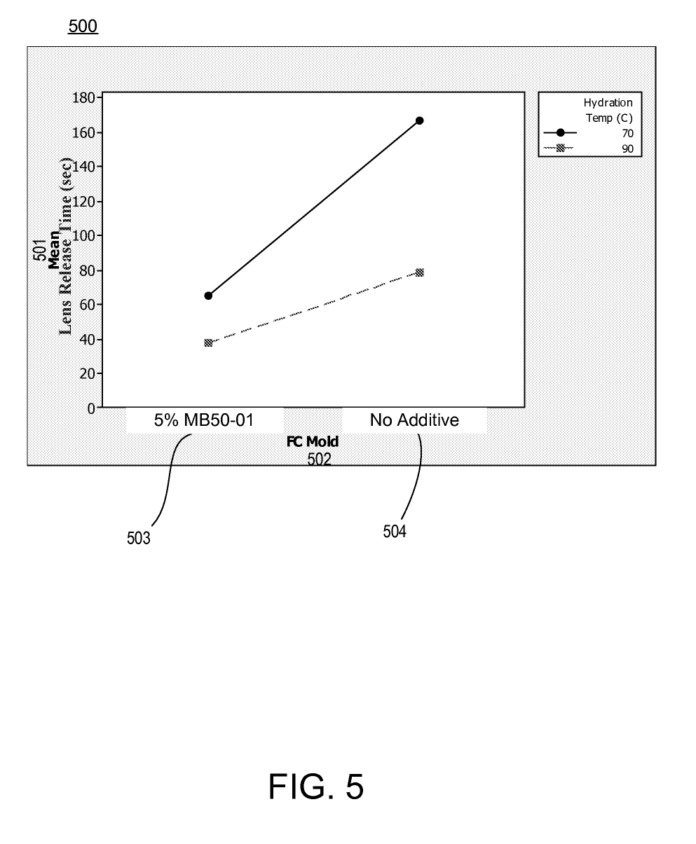

Referring now to FIG. 5, a graph 500 illustrates how those materials with reduced mold surface energy facilitate improved release of lenses from the mold parts with the reduced surface energy, wherein the reduced surface energy resulted in a faster release time of a lens from a FC mold part. Specifically, polypropylene with 5% MB50-001 which has a relatively low surface energy of 24.74 mN/m (Zisman method) 503 had a mean release time of 37 seconds at 90° C. and 65 seconds at 70° C. As exemplified in the chart a mold part material with a relatively higher surface energy, such as Zeonor 1060R which has surface energy of 43.39 mN/m, required a significantly longer time to release an ophthalmic lens formed therein. The ophthalmic lenses formed in Zeonor 1060R mold parts required 79 seconds to release at 90° C. and 170 seconds at 70° C.

TABLE 2

| | Lens Release Time (Sec) | | Lens Release Time (Sec) | |
|---|---|---|---|---|
| | (FC = Zeonor 1060R) | | (FC = PP9544 + 5% w.t. | |
| | Temp = 70 | | MB50-001) | |
| | (C.) | Temp = 90 (C.) | Temp = 70 (C.) | Temp = 90 (C.) |
| Mean | 170 | 79 | 65 | 37 |
| N | 38 | 19 | 12 | 25 |
| Std Dev | 117 | 99 | 31 | 10 |
| Max | 300 | 300 | 111 | 60 |
| Min | 20 | 18 | 20 | 20 |
| Range | 280 | 282 | 91 | 40 |

### CONCLUSION

The present invention, as described above and as further defined by the claims below, provides mold parts 101-102 fashioned from a thermal plastic resin compounded with an additive to provide an increase in a delta of the surface energy of the mold part and an ophthalmic lens formed therein.

What is claimed is:

1. An improved method of molding an ophthalmic lens, wherein a lens forming mixture is cured in a cavity of a desired shape formed by two or more mold parts;
the improvement comprising curing the lens forming mixture in a cavity formed with at least one mold part comprising a thermal plastic resin compounded with an additive to reduce the surface energy of the at least one mold part to below 30 mN/m.

2. The method of claim 1, wherein a first mold part comprises a concave surface, a second mold part comprises a convex surface, and at least the second mold part comprises a thermal plastic resin compounded with an additive to reduce the surface energy of the second mold part to below 30 mN/m.

3. The method of claim 1, wherein a first mold part comprises a concave surface and a second mold part comprises a convex surface and both the first mold part and the second mold part comprise a thermal plastic resin compounded with an additive to reduce the surface energy of both mold parts to below 30 mN/m.

4. The method of claim 1 wherein at least one of the mold parts is transparent to polymerization initiating radiation and the cavity comprises the shape and size of an ophthalmic lens, the method additionally comprising the steps of:
depositing lens forming mixture comprising a polymerizable composition in the cavity; and
exposing the mold parts and the polymerizable composition to polymerization initiating radiation.

5. The method of claim 3, wherein the surface energy of the first and second mold parts is determined with one or more of: the Owens-Wendt method and the Zisman method.

6. The method of claim 1 wherein the additive comprises one or more lipophilic non-ionic surfactants with HLB of 3.6-4.2 and a chemical formula of CH3(CH2)16COOCH2CHOHCH2OH.

7. The method of claim 1 wherein the additive comprises one or more organosilicon compounds with empirical formula R₂SiO.

8. A mold assembly for forming an ophthalmic lens, the mold assembly comprising:
a first mold part and a second mold part positioned relative to each other to form a cavity in a shape and size suitable to form an ophthalmic lens;
at least one of the first mold part and the second mold part comprising a lens forming surface; and
wherein at least one of the first mold part and the second mold part comprises a thermal plastic resin compounded with a thermal plastic elastomer.

9. The mold of claim 8 wherein the thermal plastic elastomer comprises styrene block copolymer.

10. The mold of claim 9 wherein the thermal plastic elastomer comprises one or more of the group comprising: styrene ethylene butylene; styrene ethylene propylene; and a styrene-ethylene-ethylene-propylene-styrene block copolymer.

11. The mold of claim 8 wherein the at least one of the first mold part and the second mold part comprising a thermal plastic resin compounded with a thermal plastic elastomer, comprises between about 5% weight and 75% weight thermal plastic elastomer.

12. The mold of claim 8 wherein the at least one of the first mold part and the second mold part comprising a thermal plastic resin compounded with a thermal plastic elastomer, comprises between about 10% weight and 50% weight thermal plastic elastomer.

13. The mold of claim 8 wherein the thermoplastic resin comprises an alicyclic polymer.

14. The mold of claim 8 wherein the thermoplastic resin comprises a polyolefin having a melt flow rate of less than 21 g/10 minutes and the thermal plastic resin compounded with a thermal plastic elastomer has a melt flow rate greater than about 21 g/10 minutes.

15. An ophthalmic lens produced by a method comprising the steps of:
dispensing an uncured lens formulation onto a surface of a mold part formed from a resin comprising a thermal plastic resin compounded with a thermal plastic elastomer; and
curing said lens formulation under actinic conditions suitable to the uncured lens formulation.

16. The ophthalmic lens of claim 15 wherein the uncured lens formulation comprises a silicone hydrogel formulation.

17. The lens of claim 15 wherein the uncured lens formulation comprises a hydrogel formulation.

18. The lens of claim 15 wherein the uncured lens formulation comprises at least one of: acquafilcon A, balafilcon A, and lotrafilcon A.

19. The lens of claim 15 wherein the uncured lens formulation comprises at least one of: etafilcon A, genfilcon A, lenefilcon A, polymacon and galyfilcon A, and senofilcon A.

20. The lens of claim 11 wherein the uncured lens formulation comprises senofilcon A.
